(19) United States
(12) Patent Application Publication
(10) Pub. No.: US 2024/0296753 A1
(43) Pub. Date: Sep. 5, 2024

(54) SYSTEM AND METHOD FOR ARTIFICIAL INTELLIGENCE-BASED LANGUAGE SKILL ASSESSMENT AND DEVELOPMENT USING AVATARS

(71) Applicant: Pearson Education, Inc., Bloomington, MN (US)

(72) Inventors: Ilya GOGIN, Homestead, FL (US); Sion REILLY, London (GB); Alexandru ILIESCU, Brasov (RO)

(21) Appl. No.: 18/593,507

(22) Filed: Mar. 1, 2024

Related U.S. Application Data
(60) Provisional application No. 63/449,601, filed on Mar. 2, 2023.
(60) Provisional application No. 63/548,523, filed on Nov. 14, 2023.

(51) Int. Cl. G09B 19/06; G06F 40/58; G06T 13/40

(52) U.S. Cl. CPC G09B 19/06; G06F 40/58; G06T 13/40

(57) ABSTRACT

Systems and methods for artificial intelligence-based language skill assessment and development using avatars provide for: determining a target language and a natural language of a user; generating a first avatar corresponding to the target language and a second avatar corresponding to the natural language on a graphical user interface; generating a first interaction for the first avatar using the target language where the first avatar is associated with a first generative artificial intelligence model; receiving a user input to select the second avatar; and in response to the user input, generating a second interaction for the second avatar using the natural language where the second interaction corresponds to the first interaction, the second avatar is associated with a second generative artificial intelligence model, and the second generative artificial intelligence model communicates with the first generative artificial intelligence model to produce the second interaction.

### CROSS-REFERENCE TO RELATED APPLICATIONS

This application claims priority to U.S. Provisional Application No. 63/449,601, titled SYSTEM AND METHOD FOR ARTIFICIAL INTELLIGENCE-BASED LANGUAGE SKILL ASSESSMENT AND DEVELOPMENT, filed on Mar. 2, 2023, and to U.S. Provisional Application No. 63/548,523, titled SYSTEM AND METHOD FOR ARTIFICIAL INTELLIGENCE-BASED LANGUAGE SKILL ASSESSMENT AND DEVELOPMENT USING AVATARS, filed on Nov. 14, 2023, each of which are hereby incorporated by reference in their entireties.

### TECHNICAL FIELD

This disclosure relates to the field of systems and methods for computer-based assessment and development of language skills.

### SUMMARY

The disclosed technology relates to systems and methods for artificial intelligence-based language skill assessment and development using avatars. In one example, a system for artificial intelligence-based language skill assessment and development using avatars is provided that includes a memory and an electronic processor coupled with the memory, the electronic processor is configured to: determine a target language and a natural language of a user, generate a first avatar corresponding to the target language and a second avatar corresponding to the natural language on a graphical user interface, generate a first interaction for the first avatar using the target language, receive a user input to select the second avatar, and generate a second interaction for the second avatar using the natural language in response to the user input. The first avatar is associated with a first generative artificial intelligence model while the second avatar is associated with a second generative artificial intelligence model. The second interaction corresponds to the first interaction. The second generative artificial intelligence model communicates with the first generative artificial intelligence model to produce the second interaction.

In another example, a method for artificial intelligence-based language skill assessment and development using avatars is provided. The method includes: determining, by an electronic processor, a target language and a natural language of a user; generating, by the electronic processor, a first avatar corresponding to the target language and a second avatar corresponding to the natural language on a graphical user interface; generating, by the electronic processor, a first interaction for the first avatar using the target language, the first avatar being associated with a first generative artificial intelligence model; receiving, by the electronic processor, a user input to select the second avatar; and in response to the user input, generating, by the electronic processor, a second interaction for the second avatar using the natural language, the second interaction being associated with the first interaction, the second avatar being associated with a second generative artificial intelligence model, the second generative artificial intelligence model communicating with the first generative artificial intelligence model to produce the second interaction.

The above features and advantages of the present invention will be better understood from the following detailed description taken in conjunction with the accompanying drawings.

### BRIEF DESCRIPTION OF THE DRAWINGS

FIG. 1 illustrates a system level block diagram for providing the disclosed language skill assessment and development system architecture.

FIG. 2 illustrates a system level block diagram for providing the disclosed language skill assessment and development system architecture, in accordance with various aspects of the techniques described in this disclosure.

FIG. 3 illustrates a system level block diagram of a content management system that facilitates the disclosed language skill assessment and development system architecture, in accordance with various aspects of the techniques described in this disclosure.

FIG. 4 is a block diagram for providing the language skill assessment and development system architecture with one or more avatars, in accordance with various aspects of the techniques described in this disclosure.

FIG. 5 illustrates a process for a language skill assessment and development system using avatars, in accordance with various aspects of the techniques described in this disclosure.

FIG. 6A is a schematic diagram conceptually illustrating an example screen of a GUI for an avatar, FIG. 6B is a schematic diagram conceptually illustrating an example screen of a GUI for the avatars, FIG. 6C is a schematic diagram conceptually illustrating an example screen of a GUI for another avatar, in accordance with various aspects of the techniques described in this disclosure, and FIG. 6D is a schematic diagram conceptually illustrating example screens of GUIs for another avatar.

FIG. 7 is a schematic diagram conceptually illustrating example screens of GUIs for different avatars with different characteristics.

FIG. 8 is a schematic diagram conceptually illustrating an example screen of a GUI for different discussion topics.

FIG. 9A is a schematic diagram conceptually illustrating an example screen of a GUI for a role play topic, FIG. 9B is a schematic diagram conceptually illustrating an example screen of a GUI for tasks, FIG. 9C is a schematic diagram conceptually illustrating an example screen of a GUI for an avatar for the role play, and FIG. 9D is a schematic diagram conceptually illustrating an example screen of a GUI for an assessment result for the role play.

FIG. 10 is a schematic diagram conceptually illustrating example screens of GUIs for assessment results.

### DETAILED DESCRIPTION

The disclosed technology will now be discussed in detail with regard to the attached drawing figures that were briefly described above. In the following description, numerous specific details are set forth illustrating the Applicant's best mode for practicing the invention and enabling one of ordinary skill in the art to make and use the invention. It will be obvious, however, to one skilled in the art that the present invention may be practiced without many of these specific details. In other instances, well-known machines, structures, and method steps have not been described in particular detail in order to avoid unnecessarily obscuring the present invention. Unless otherwise indicated, like parts and method steps are referred to with like reference numerals.

Speaking practice and access to a personal tutor have been among the least addressed needs of language learners. Previous computer-based language learning solutions have provided only very basic speaking practice that was constrained and mostly involved recording words or sentences of pronunciation. Similarly, access to private language tutors was not affordable to most learners. Private language tutors are also subjective in providing feedback and are only available at a limited time based on the private language tutors' schedules. Further, language learners have difficulty finding target language users to practice speaking. Limited offerings by computer-based language learning solutions have not sufficiently addressed either the lack of access to private language tutors or to target language users to practice speaking. Thus, current computer-based language learning systems and methods are unable to objectively provide feedback to language learners and unable to provide an environment for language learners to practice speaking.

The disclosed system includes, among other things, generative artificial intelligence model(s), and conversational artificial intelligence model(s) with digital avatar(s) to create a human-like conversational language person that would look like a human (in a virtual reality environment), speak like a human, and that will provide personalized tutoring support like a human tutor. Furthermore, the disclosed system uses multiple generative artificial intelligence models to communicate with each other and provide effective assistance and/or feedback to the user in real time. Thus, the disclosed system can improve user's language proficiency in an environment similar to the real world by having a conversation with one or more avatars, which speak like a human and provide feedback in real time.

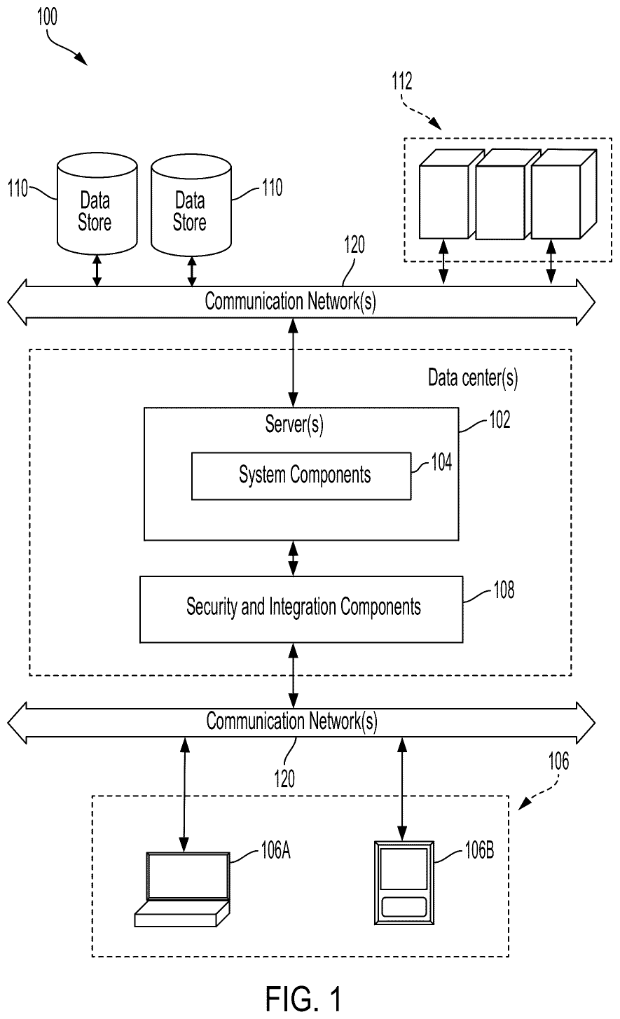

FIG. 1 illustrates a non-limiting example of a distributed computing environment 100. In some examples, the distributed computing environment 100 may include one or more server(s) 102 (e.g., data servers, computing devices, computers, etc.), one or more client computing devices 106, and other components that may implement certain embodiments and features described herein. Other devices, such as specialized sensor devices, etc., may interact with the client computing device(s) 106 and/or the server(s) 102. The server(s) 102, client computing device(s) 106, or any other devices may be configured to implement a client-server model or any other distributed computing architecture. In an illustrative and non-limiting example, the client devices 106 may include a first client device 106A and a second client device 106B. The first client device 106A may correspond to a first user in a class and the second client device 106B may correspond to a second user in the class or another class.

In some examples, the server(s) 102, the client computing device(s) 106, and any other disclosed devices may be communicatively coupled via one or more communication network(s) 120. The communication network(s) 120 may be any type of network known in the art supporting data communications. As non-limiting examples, network 120 may be a local area network (LAN; e.g., Ethernet, Token-Ring, etc.), a wide-area network (e.g., the Internet), an infrared or wireless network, a public switched telephone networks (PSTNs), a virtual network, etc. Network 120 may use any available protocols, such as, e.g., transmission control protocol/Internet protocol (TCP/IP), systems network architecture (SNA), Internet packet exchange (IPX), Secure Sockets Layer (SSL), Transport Layer Security (TLS), Hypertext Transfer Protocol (HTTP), Secure Hypertext Transfer Protocol (HTTPS), Institute of Electrical and Electronics (IEEE) 802.11 protocol suite or other wireless protocols, and the like.

The embodiments shown in FIGS. 1 and/or 2 are respective examples of a distributed computing system and are not intended to be limiting. The subsystems and components within the server(s) 102 and the client computing device(s) 106 may be implemented in hardware, firmware, software, or combinations thereof. Various different subsystems and/or components 104 may be implemented on server 102. Users operating the client computing device(s) 106 may initiate one or more client applications to use services provided by these subsystems and components. Various different system configurations are possible in different distributed computing environments 100 and content distribution networks. Server 102 may be configured to run one or more server software applications or services, for example, web-based or cloud-based services, to support content distribution and interaction with client computing device(s) 106. Users operating client computing device(s) 106 may in turn utilize one or more client applications (e.g., virtual client applications) to interact with server 102 to utilize the services provided by these components. The client computing device(s) 106 may be configured to receive and execute client applications over the communication network(s) 120. Such client applications may be web browser-based applications and/or standalone software applications, such as mobile device applications. The client computing device(s) 106 may receive client applications from server 102 or from other application providers (e.g., public or private application stores).

As shown in FIG. 1, various security and integration components 108 may be used to manage communications over the communication network(s) 120 (e.g., a file-based integration scheme, a service-based integration scheme, etc.). In some examples, the security and integration components 108 may implement various security features for data transmission and storage, such as authenticating users or restricting access to unknown or unauthorized users. As non-limiting examples, the security and integration components 108 may include dedicated hardware, specialized networking components, and/or software (e.g., web servers, authentication servers, firewalls, routers, gateways, load balancers, etc.) within one or more data centers in one or more physical location(s) and/or operated by one or more entities, and/or may be operated within a cloud infrastructure. In various implementations, the security and integration components 108 may transmit data between the various devices in the distribution computing environment 100 (e.g., in a content distribution system or network). In some examples, the security and integration components 108 may use secure data transmission protocols and/or encryption (e.g., File Transfer Protocol (FTP), Secure File Transfer Protocol (SFTP), and/or Pretty Good Privacy (PGP) encryption) for data transfers, etc.).

In some examples, the security and integration components 108 may implement one or more web services (e.g., cross-domain and/or cross-platform web services) within the distribution computing environment 100, and may be developed for enterprise use in accordance with various web service standards (e.g., the Web Service Interoperability (WS-I) guidelines). In an example, some web services may provide secure connections, authentication, and/or confidentiality throughout the network using technologies such as SSL, TLS, HTTP, HTTPS, WS-Security standard (providing secure SOAP messages using XML encryption), etc. In some examples, the security and integration components 108 may include specialized hardware, network appliances, and the like (e.g., hardware-accelerated SSL and HTTPS), possibly installed and configured between one or more server(s) 102 and other network components. In such examples, the security and integration components 108 may thus provide secure web services, thereby allowing any external devices to communicate directly with the specialized hardware, network appliances, etc.

A distribution computing environment 100 may further include one or more data stores 110. In some examples, the one or more data stores 110 may include, and/or reside on, one or more back-end servers 112, operating in one or more data center(s) in one or more physical locations. In such examples, the one or more data stores 110 may communicate data between one or more devices, such as those connected via the one or more communication network(s) 120. In some cases, the one or more data stores 110 may reside on a non-transitory storage medium within one or more server(s) 102. In some examples, data stores 110 and back-end servers 112 may reside in a storage-area network (SAN). In addition, access to one or more data stores 110, in some examples, may be limited and/or denied based on the processes, user credentials, and/or devices attempting to interact with the one or more data stores 110.

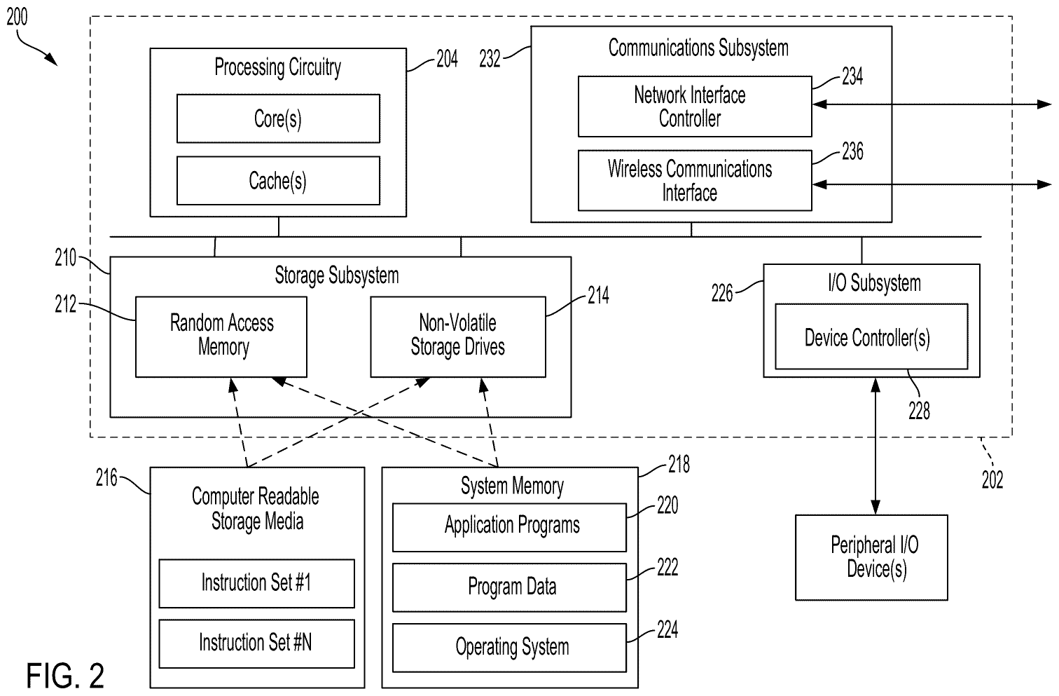

With reference now to FIG. 2, a block diagram of an example computing system 200 is shown. The computing system 200 (e.g., one or more computers) may correspond to any one or more of the computing devices or servers of the distribution computing environment 100, or any other computing devices described herein. In an example, the computing system 200 may represent an example of one or more server(s) 102 and/or of one or more server(s) 112 of the distribution computing environment 100. In another example, the computing system 200 may represent an example of the client computing device(s) 106 of the distribution computing environment 100. In some examples, the computing system 200 may represent a combination of one or more computing devices and/or servers of the distribution computing environment 100.

In some examples, the computing system 200 may include processing circuitry 204, such as one or more processing unit(s), processor(s), etc. In some examples, the processing circuitry 204 may communicate (e.g., interface) with a number of peripheral subsystems via a bus subsystem 202. These peripheral subsystems may include, for example, a storage subsystem 210, an input/output (I/O) subsystem 226, and a communications subsystem 232.

In some examples, the processing circuitry 204 may be implemented as one or more integrated circuits (e.g., a conventional micro-processor or microcontroller). In an example, the processing circuitry 204 may control the operation of the computing system 200. The processing circuitry 204 may include single core and/or multicore (e.g., quad core, hexa-core, octo-core, ten-core, etc.) processors and processor caches. The processing circuitry 204 may execute a variety of resident software processes embodied in program code, and may maintain multiple concurrently executing programs or processes. In some examples, the processing circuitry 204 may include one or more specialized processors, (e.g., digital signal processors (DSPs), outboard, graphics application-specific, and/or other processors).

In some examples, the bus subsystem 202 provides a mechanism for intended communication between the various components and subsystems of computing system 200. Although the bus subsystem 202 is shown schematically as a single bus, alternative embodiments of the bus subsystem may utilize multiple buses. In some examples, the bus subsystem 202 may include a memory bus, memory controller, peripheral bus, and/or local bus using any of a variety of bus architectures (e.g., Industry Standard Architecture (ISA), Micro Channel Architecture (MCA), Enhanced ISA (EISA), Video Electronics Standards Association (VESA), and/or Peripheral Component Interconnect (PCI) bus, possibly implemented as a Mezzanine bus manufactured to the IEEE P1386.1 standard).

In some examples, the I/O subsystem 226 may include one or more device controller(s) 228 for one or more user interface input devices and/or user interface output devices, possibly integrated with the computing system 200 (e.g., integrated audio/video systems, and/or touchscreen displays), or may be separate peripheral devices which are attachable/detachable from the computing system 200. Input may include keyboard or mouse input, audio input (e.g., spoken commands), motion sensing, gesture recognition (e.g., eye gestures), etc. As non-limiting examples, input devices may include a keyboard, pointing devices (e.g., mouse, trackball, and associated input), touchpads, touch screens, scroll wheels, click wheels, dials, buttons, switches, keypad, audio input devices, voice command recognition systems, microphones, three dimensional (3D) mice, joysticks, pointing sticks, gamepads, graphic tablets, speakers, digital cameras, digital camcorders, portable media players, webcams, image scanners, fingerprint scanners, barcode readers, 3D scanners, 3D printers, laser rangefinders, eye gaze tracking devices, medical imaging input devices, MIDI keyboards, digital musical instruments, and the like. In general, use of the term “output device” is intended to include all possible types of devices and mechanisms for outputting information from computing system 200, such as to a user (e.g., via a display device) or any other computing system, such as a second computing system 200. In an example, output devices may include one or more display subsystems and/or display devices that visually convey text, graphics and audio/video information (e.g., cathode ray tube (CRT) displays, flat-panel devices, liquid crystal display (LCD) or plasma display devices, projection devices, touch screens, etc.), and/or may include one or more non-visual display subsystems and/or non-visual display devices, such as audio output devices, etc. As non-limiting examples, output devices may include, indicator lights, monitors, printers, speakers, headphones, automotive navigation systems, plotters, voice output devices, modems, etc.

In some examples, the computing system 200 may include one or more storage subsystems 210, including hardware and software components used for storing data and program instructions, such as system memory 218 and computer-readable storage media 216. In some examples, the system memory 218 and/or the computer-readable storage media 216 may store and/or include program instructions that are loadable and executable on the processor(s) 204. In an example, the system memory 218 may load and/or execute an operating system 224, program data 222, server applications, application program(s) 220 (e.g., client applications), Internet browsers, mid-tier applications, etc. In some examples, the system memory 218 may further store data generated during execution of these instructions.

In some examples, the system memory 218 may be stored in volatile memory (e.g., random-access memory (RAM) 212, including static random-access memory (SRAM) or dynamic random-access memory (DRAM)). In an example, the RAM 212 may contain data and/or program modules that are immediately accessible to and/or operated and executed by the processing circuitry 204. In some examples, the system memory 218 may also be stored in non-volatile storage drives 214 (e.g., read-only memory (ROM), flash memory, etc.). In an example, a basic input/output system (BIOS), containing the basic routines that help to transfer information between elements within the computing system 200 (e.g., during start-up), may typically be stored in the non-volatile storage drives 214.

In some examples, the storage subsystem 210 may include one or more tangible computer-readable storage media 216 for storing the basic programming and data constructs that provide the functionality of some embodiments. In an example, the storage subsystem 210 may include software, programs, code modules, instructions, etc., that may be executed by the processing circuitry 204, in order to provide the functionality described herein. In some examples, data generated from the executed software, programs, code, modules, or instructions may be stored within a data storage repository within the storage subsystem 210. In some examples, the storage subsystem 210 may also include a computer-readable storage media reader connected to the computer-readable storage media 216.

In some examples, the computer-readable storage media 216 may contain program code, or portions of program code. Together and, optionally, in combination with the system memory 218, the computer-readable storage media 216 may comprehensively represent remote, local, fixed, and/or removable storage devices plus storage media for temporarily and/or more permanently containing, storing, transmitting, and/or retrieving computer-readable information. In some examples, the computer-readable storage media 216 may include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer-readable media. This can also include nontangible computer-readable media, such as data signals, data transmissions, or any other medium which can be used to transmit the desired information and which can be accessed by the computing system 200. In an illustrative and non-limiting example, the computer-readable storage media 216 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media.

In some examples, the computer-readable storage media 216 may include, but is not limited to, Zip® drives, flash memory cards, universal serial bus (USB) flash drives, secure digital (SD) cards, DVD disks, digital video tape, and the like. In some examples, the computer-readable storage media 216 may include, solid-state drives (SSD) based on non-volatile memory such as flash-memory based SSDs, enterprise flash drives, solid state ROM, and the like, SSDs based on volatile memory such as solid-state RAM, dynamic RAM, static RAM, DRAM-based SSDs, magneto-resistive RAM (MRAM) SSDs, and hybrid SSDs that use a combination of DRAM and flash memory-based SSDs. The disk drives and their associated computer-readable media may provide non-volatile storage of computer-readable instructions, data structures, program modules, and other data for the computing system 200.

In some examples, the communications subsystem 232 may provide a communication interface from the computing system 200 and external computing devices via one or more communication networks, including local area networks (LANs), wide area networks (WANs) (e.g., the Internet), and various wireless telecommunications networks. As illustrated in FIG. 2, the communications subsystem 232 may include, for example, one or more network interface controllers (NICs) 234, such as Ethernet cards, Asynchronous Transfer Mode NICs, Token Ring NICs, and the like, as well as one or more wireless communications interfaces 236, such as wireless network interface controllers (WNICs), wireless network adapters, and the like. Additionally, and/or alternatively, the communications subsystem 232 may include one or more modems (telephone, satellite, cable, ISDN), synchronous or asynchronous digital subscriber line (DSL) units, Fire Wire® interfaces, USB® interfaces, and the like. Communications subsystem 232 also may include radio frequency (RF) transceiver components for accessing wireless voice and/or data networks (e.g., using cellular telephone technology, advanced data network technology, such as 3G, 4G, 5G or EDGE (enhanced data rates for global evolution), Wi-Fi (IEEE 802.11 family standards, or other mobile communication technologies, or any combination thereof), global positioning system (GPS) receiver components, and/or other components.

In some examples, the communications subsystem 232 may also receive input communication in the form of structured and/or unstructured data feeds, event streams, event updates, and the like, on behalf of one or more users who may use or access the computing system 200. In an example, the communications subsystem 232 may be configured to receive data feeds in real-time from users of social networks and/or other communication services, web feeds such as Rich Site Summary (RSS) feeds, and/or real-time updates from one or more third party information sources (e.g., data aggregators). Additionally, the communications subsystem 232 may be configured to receive data in the form of continuous data streams, which may include event streams of real-time events and/or event updates (e.g., sensor data applications, financial tickers, network performance measuring tools, clickstream analysis tools, automobile traffic monitoring, etc.). In some examples, the communications subsystem 232 may output such structured and/or unstructured data feeds, event streams, event updates, and the like to one or more data stores that may be in communication with one or more streaming data source computing systems (e.g., one or more data source computers, etc.) coupled to the computing system 200. The various physical components of the communications subsystem 232 may be detachable components coupled to the computing system 200 via a computer network (e.g., a communication network 120), a FireWire® bus, or the like, and/or may be physically integrated onto a motherboard of the computing system 200. In some examples, the communications subsystem 232 may be implemented in whole or in part by software.

Due to the ever-changing nature of computers and networks, the description of the computing system 200 depicted in the figure is intended only as a specific example. Many other configurations having more or fewer components than the system depicted in the figure are possible. For example, customized hardware might also be used and/or particular elements might be implemented in hardware, firmware, software, or a combination. Further, connection to other computing devices, such as network input/output devices, may be employed. Based on the disclosure and teachings provided herein, a person of ordinary skill in the art will appreciate other ways and/or methods to implement the various embodiments.

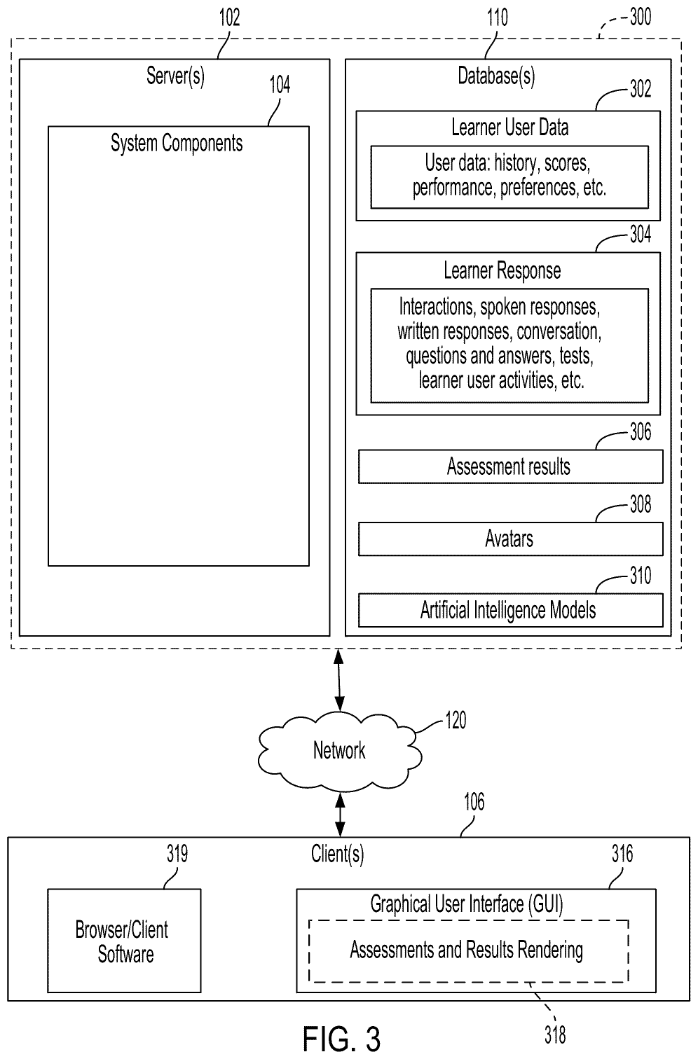

FIG. 3 illustrates a system level block diagram of a language assessment and development system 300, such as a user assessment system for providing the disclosed assessment results according to some examples. In some examples, the language assessment and development system 300 may include one or more database(s) 110, also referred to as data stores herein. The database(s) 110 may include a plurality of user data 302 (e.g., a set of user data items). In such examples, the language assessment and development system 300 may store and/or manage the user data 302 in accordance with one or more of the various techniques of the disclosure. In some examples, the user data 302 may include user responses, user history, user scores, user performance, user preferences, and the like.

In some examples, the language assessment and development system 300 may utilize the user data to determine the level of assessments, and in some examples, the language assessment and development system 300 may customize the level of assessments and/or conversation for a particular user (e.g., a learner user). In some examples, the language assessment and development system 300 may collect and aggregate some or all proficiency estimates and evidence points from various sources (e.g., platforms, learner response assessment component, a personalization component, a pronunciation assessment, a practice generation component, etc.) to determine the level of assessments. The level of assessments can be stored in the database 110. In further examples, the level of assessments may be received by other sources (e.g., third-party components).

In addition, the database(s) 110 may include learner response(s) 304. In some examples, the learner response 304 may include multiple interactions of a user, and an interaction may include a spoken response or a written response. In some examples, the learner response(s) is generated during a conversation, questions and answers, tests, and other various user activities.

In addition, the database(s) 110 may further include assessment result(s) 306. For example, the language assessment and development system 300 can produce assessment result(s) 306 using multiple assessments for learner response(s) 304 and store the assessment result(s) 306 in the database 110.

In addition, the database(s) 110 may further include avatars 308. For example, the avatars can be associated with corresponding generative artificial intelligence models to communicate with the user. In some examples, each generative artificial intelligence model can be communicatively coupled to each other and be aware of a conversation with the user using a generative artificial intelligence model.

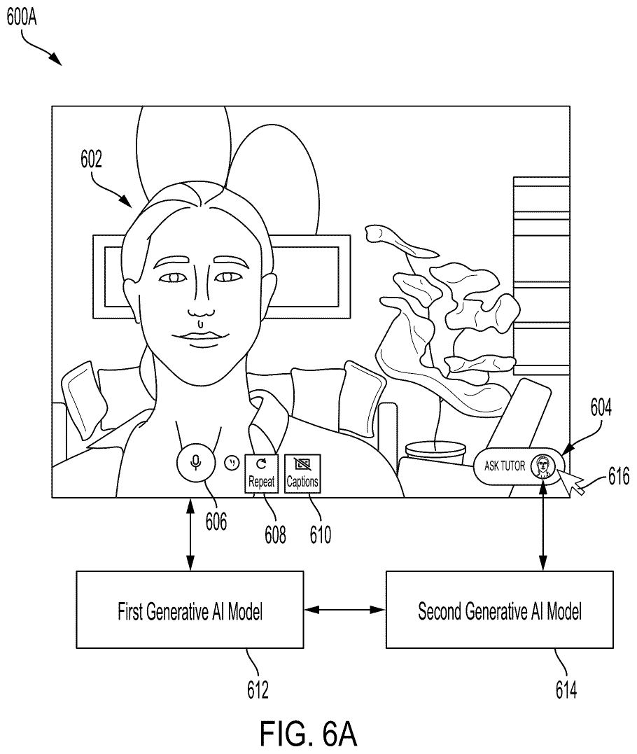

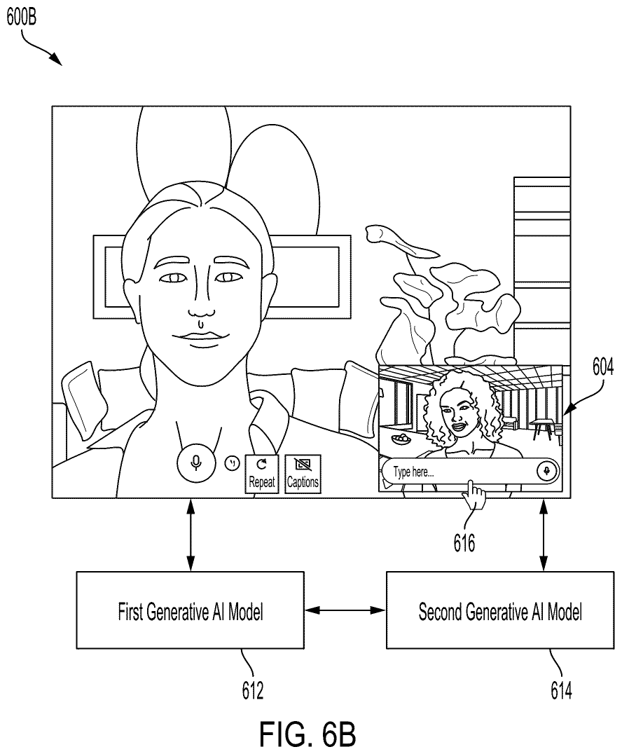

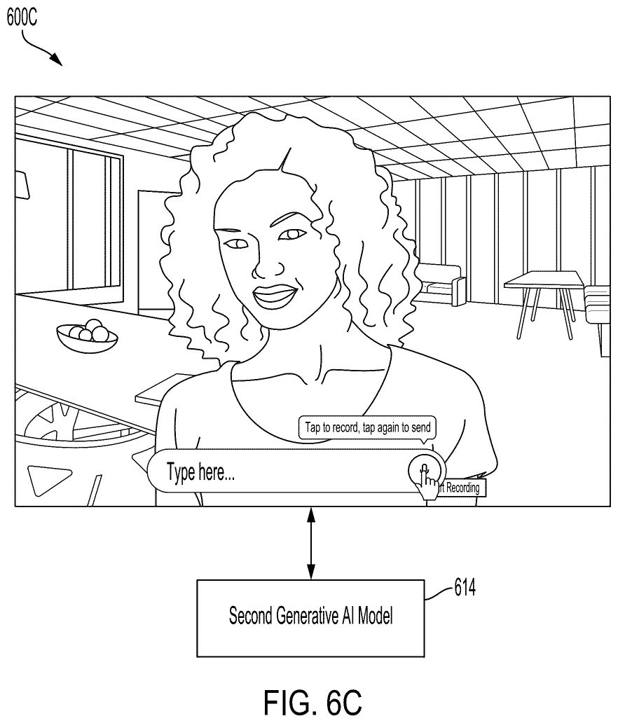

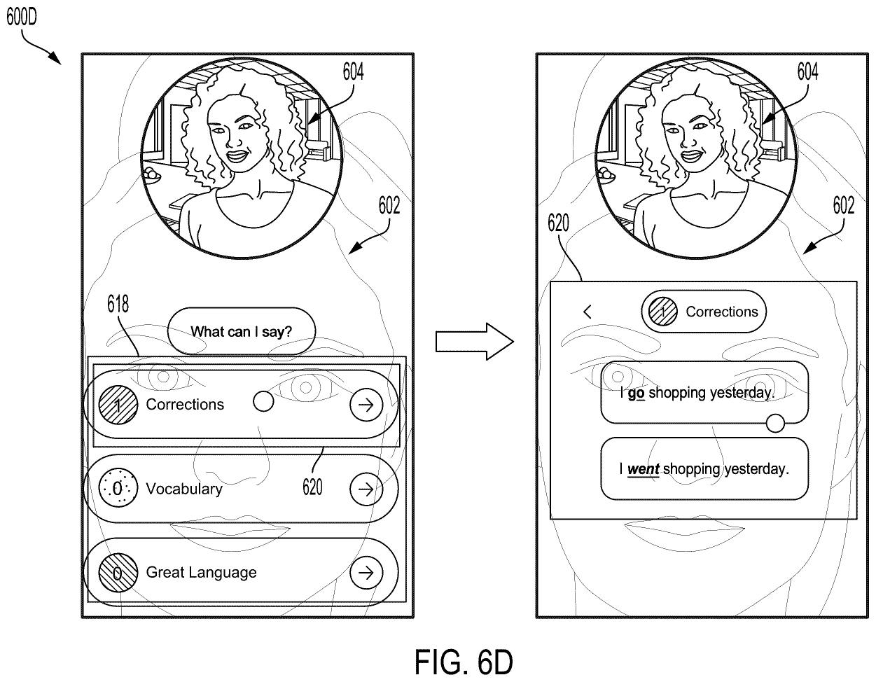

Further, the database(s) 110 may further include artificial intelligence (AI) models 310. For example, the AI models 310 can correspond to the avatars 308 such that the AI models 310 may be accessed by the server 102 to control the output of the corresponding avatars 308. In some examples, the AI models 310 can include generative AI models. In other examples, the AI models 310 can include recurrent neural networks (RNNs), convolutional neural networks (CNNs), transformer models, sequence-to-sequence models, word embeddings, memory networks, graph neural networks or any other suitable artificial intelligence model to process language. AI models 612 and 614, described in further detail below (e.g., with respect to FIGS. 6A to 6C), may be examples of the AI models 310. In further examples, the artificial intelligence models 310 and/or the avatars 308 can be stored in a remote or cloud server, which is communicatively coupled to the system server 102 over the network 120.

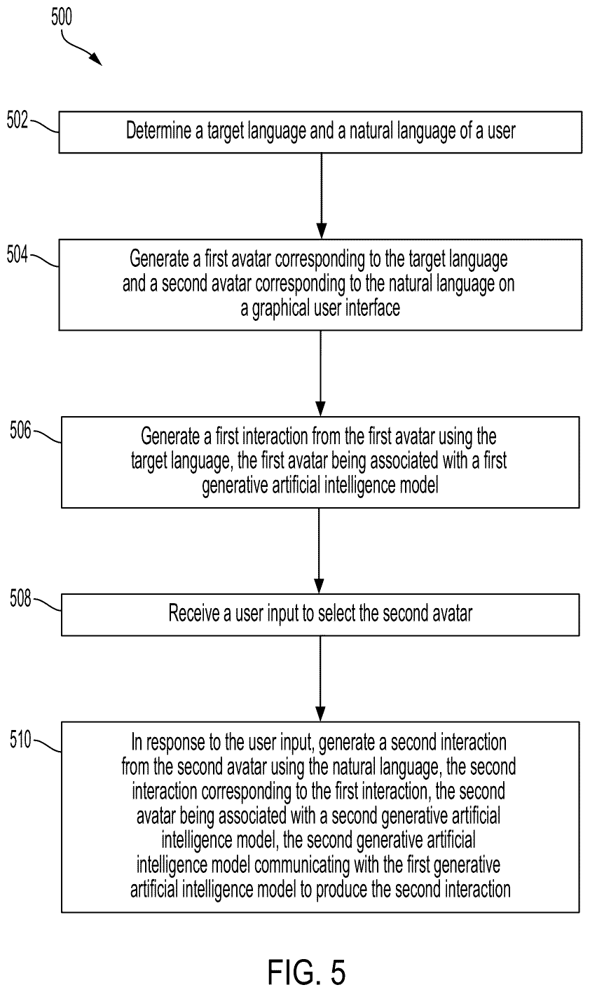

In some aspects of the disclosure, the server 102 in coordination with the database(s) 110 may configure the system components 104 (e.g., generative artificial intelligence models (can be stored in the database(s) 110)) for various functions, including, e.g., determining a target language and a natural language of a user; generating a first avatar corresponding to the target language and a second avatar corresponding to the natural language on a graphical user interface; generating a first interaction for the first avatar using the target language; receiving a user input to select the second avatar; in response to the user input, generating a second interaction for the second avatar using the natural language; assigning the first characteristic to the first generative artificial intelligence model being associated with the first avatar; assigning the second characteristic to the second generative artificial intelligence model being associated with the second avatar; providing one or more third interactions from the second avatar using the target language in response to the user input; generating one or more fourth interactions from the second avatar; receiving a third interaction from the user, the third interaction being responsive to the first interaction; determining whether a relevance score of the third interaction is higher than a predetermined threshold; in response to the determining of the relevance score being higher than the predetermined threshold, generating a fourth interaction from the first avatar, the fourth interaction being responsive to the third interaction; in response to the determining of the relevance score being equal or lower than the predetermined threshold, providing a fourth interaction from the first avatar, the fourth interaction being indicative of irrelevance to the third interaction; converting the third interaction to a written interaction; inputting the written interaction to the first generative artificial intelligence model for a response interaction corresponding to the target language; receiving the response interaction from the first generative artificial intelligence model; providing the response interaction by the first avatar to the user; and/or when the first interaction is provided from the first avatar, generating the first avatar being bigger than the second avatar on the graphical user interface. For example, the system components 104 may be configured to implement one or more of the functions described below in relation to FIG. 5, including, e.g., blocks 502-510. The system components 104 may, in some examples, be implemented by an electronic processor of the server 102 (e.g., processing circuitry 204 of FIG. 2) executing instructions stored and retrieved from a memory of the server 102 (e.g., storage subsystem 210, computer readable storage media 216, and/or system memory 218 of FIG. 2).

In some examples, the language assessment and development system 300 may interact with the client computing device(s) 106 via one or more communication network(s) 120. In some examples, the client computing device(s) 106 can include a graphical user interface (GUI) 316 to display assessments 318 (e.g., conversation, interactions, questions and answers, tests, etc.). and assessment results for the user. In some examples, the GUI 316 may be generated in part by execution by the client 106 of browser/client software 319 and based on data received from the system 300 via the network 120.

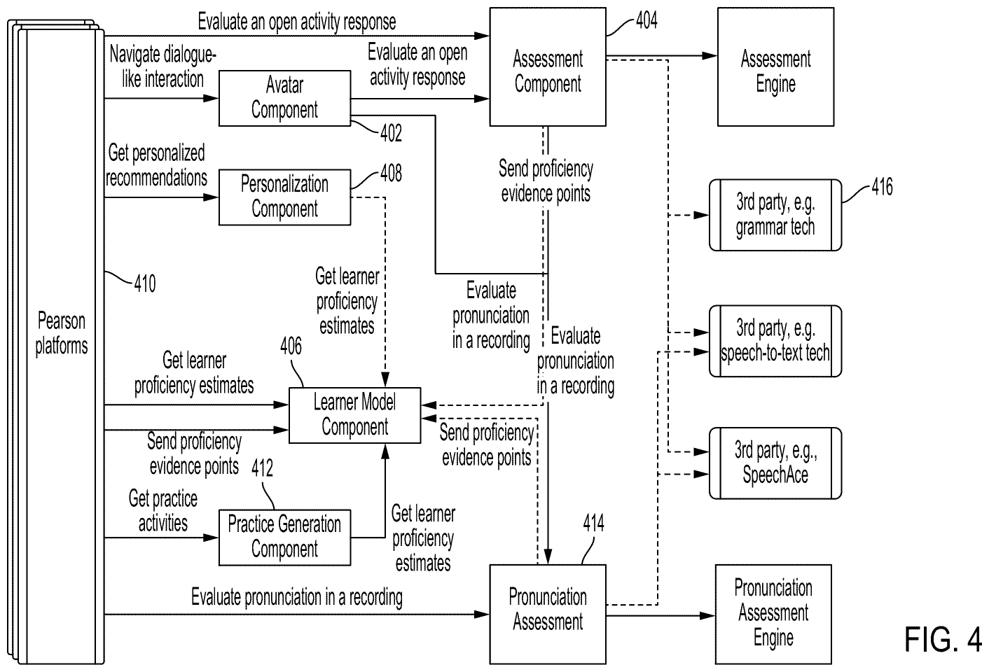

FIG. 4 is a block diagram for providing the language skill assessment and development system architecture. In some examples, interactions can be produced from an avatar component 402 (e.g., by communicating with one or more avatars as shown in FIGS. 6A-6C). In further examples, further interactions can be produced during a conversation, questions and answers, tests, and other various user activities test and/or be received from various sources (e.g., system platforms, third-party platforms). In some examples, the interactions from the avatar component 402 or any other suitable sources can be provided to an assessment component 404 to assess proficiencies of the interactions. For example, the assessment component 404 can perform a grammar assessment, a content assessment, a vocabulary & discourse assessment, or any other suitable assessment. In further examples, the interactions can be provided to perform a pronunciation assessment 414. In some examples, the server 102 can select a topic of the conversation with the avatar(s) based on indications of the user. For example, the indications can be included in a profile and/or behavioral data of the user or can be provided by the user. In some scenarios, the server 102 can select a topic for the conversation based on the user's career, interesting subjects, or any other suitable personal information for the user, which is stored in the user data 302. In further examples, the server 102 can select a proficiency level for the conversation based on proficiency estimates of the user. In some examples, a learner model component 406 can collect and aggregate all proficiency estimates and evidence points in all areas (e.g., “past simple questions,” “pronunciation of the word ‘queue,’” “participation in a business meeting,” user profile, behavioral data, etc.). In further examples, the learner model component 406 can collect proficiency estimates and evidence points from the avatar component 402, a personalization component 408, a system platforms 410, a practice generation component 412, a pronunciation assessment 414. It should be appreciated that the proficiency estimates and evidence points can be collected from any other suitable sources (e.g., third party database) and can be aggregated to produce aggregated proficiency indications. In further examples, the server 102 can select the conversation based on the aggregated proficiency indications of the user from the learner model component 406. In even further examples, the server 102 can select a proficiency level for each categorized area (e.g., subject, topic, grammar, vocabulary, pronunciation, etc.) of the conversation between the avatar component 402 and the user.

FIG. 5 illustrates a process 500 for a language skill assessment and development system using avatars, in accordance with various aspects of the techniques described in this disclosure. The flowchart of FIG. 5 utilizes various system components that are described below with reference to FIGS. 1-4 and 6A-6C. In some examples, the process 500 may be carried out by the server(s) 102 illustrated in FIG. 3, e.g., employing circuitry and/or software configured according to the block diagram illustrated in FIG. 2. In some examples, the process 500 may be carried out by any suitable apparatus or means for carrying out the functions or algorithm described below. Additionally, although the blocks of the process 500 are presented in a sequential manner, in some examples, one or more of the blocks may be performed in a different order than presented, in parallel with another block, or bypassed.

At block 502, a server (e.g., one or more of the server(s) 102, also referred to as the server 102) determines a target language and a natural language of a user. In some examples, the user via the client device 106 can provide a user input to select the target language and the natural language to the server 102 over communication network 120. The user input can be provided as text and entered via a keyboard, provided as an audio signal captured via a microphone, provided as an indication of a language, or selection generated via a graphical user interface (e.g., via drop down menu, virtual scroll wheel, soft button selection, etc.) using a touch screen, mouse, or other input device. In such examples, the server 102 can determine the target language and the natural language based on the user input. In some examples, the server 102 can determine the target language and natural language from a memory (e.g., data store 110 or a system memory 218) or via a communication from another device received via network 120. In some examples, the target language and the natural language are two different languages. For example, the target language can be English while the natural language can be Spanish, the target language can be German while the natural language can be French, the target language can be Chinese while the natural language can be Portuguese, or another combination of languages. That is, the target language and the natural language can be any two different languages.

At block 504, the server 102 generates a first avatar corresponding to the target language and a second avatar corresponding to the natural language on a graphical user interface (e.g., of a client device 106 of the user). In some examples, the first avatar and/or the second avatar can include a digital character, a digital human (or digital person, metahuman, humanoid, etc.), and a non-player-character (NPC). The digital human as an avatar can be a highly realistic computer graphic character that demonstrates highly realistic facial features, emotions, lip movements, and (when communicatively coupled with an artificial intelligence model) highly intelligent capabilities to speak. A digital human is shown with high visual and emotional fidelity because the digital human generates very fine muscle movements controlled by sophisticated algorithms (unlike digital characters that have a smaller repertoire of simple cartoon-like animations). In some examples, a digital character as an avatar can be a human-like digital avatar that has less visual fidelity than the digital human. The digital character can use simpler animations (e.g., cartoon characters) that loop through a few poses and expressions, unlike the digital human that generates finer emotional states and movements through the use of artificial intelligence models and more sophisticated muscle control. An NPC is a character (e.g., in a video game) that play the role of different human-like characters but that are not controlled by human player). For instance, in a multiplayer game with NPCs, there will be dozens of digital characters controlled by gamers (players) and many more characters controlled by the system to create an effect of a crowded social place. In some examples, an NPC can be scripted, where they have a fixed set of phrases they say, or they can be unscripted by being connected to generative artificial intelligence model. In some examples, NPCs are characters located inside an open multiplayer world in the virtual reality. NPCs are connected to one or more generative artificial intelligence models and have different personalities and storylines, designed to provide interesting conversational practice to language learners who can interact with NPCs or with other learners. In some examples, a digital human or digital character may serve as an NPC.

Referring to FIG. 6A, in some examples, the server 102 can generate a first avatar 602 as a digital human and a second avatar 604 as a digital human on the graphical user interface 600A to be displayed on the client device 106. The first avatar 602 may serve as the first avatar corresponding to the target language (referenced in block 504 of FIG. 5), and the second avatar 604 may serve as the second avatar corresponding to the natural language (referenced in block 504 of FIG. 5). The second avatar 604 may also be referred to as an avatar tutor or as a digital human tutor. In FIG. 6A, the second avatar 604 is shown in a smaller scale than the first avatar 602. By showing the second avatar 604 at a smaller scale than the first avatar 604, the system may indicate to the user that the second avatar 604 is currently inactive in or in a background of a conversation between the first avatar 602 and the user (e.g., potentially “listening,” but not speaking). In some examples, the graphical user interface 600A can further include a recording indication 606. When the user clicks or selects the recording indication 606, the server 102 is ready to receive the user's interaction (e.g., spoken words, phrases, or sentence(s)), and the first avatar 602 can be controlled to pose in a position to indicating an intent to listen to the user's interaction. In further examples, the graphical user interface 600A can further include a repeat indication 608 and/or a caption indication 610. For example, when the user clicks or selects the repeat indication 608, the server 102 can cause the first avatar 602 to repeat a word, phrase, or sentence that the first avatar 602 most recently stated. When the user clicks or selects the caption indication 610, the server 102 can transcribe what the first avatar 602 is saying and provide the transcribed words or sentences on the graphical user interface 600A.

As indicated in FIG. 6A, the first avatar 602 may correspond to a first generative artificial intelligence (AI) model 612 and the second avatar 604 may correspond to a second generative artificial intelligence (AI) model 614. As described in further detail herein, the respective generative AI models 612, 614 may be accessed by the server 102 to control the output of the corresponding avatars 602, 604. The respective generative AI models 612, 614 may each be a trained deep neural network, such as a large language model (LLM) chatbot that are able to generate responses to prompts. The respective generative AI models 612, 614 may be trained with training data that includes, for example, books, articles, texts, and the like. In some examples, the respective generative AI models 612, 614 may be different, unique, or distinct instances or sessions of the same generative AI model, thus acting as different generative AI models 612, 614 from the perspective of devices interacting with the models. For example, as a general matter, the models may be closed systems with respect to one another where, in normal operation, the first generative AI model 612 is not aware of the interactions with the second generative AI model 614, and vice versa, unless instructed to share information with one another. In other examples, the respective generative AI models 612, 614 are different, unique, or distinct generative AI models.

In some examples, to generate the first avatar 602 and the second avatar 604 in block 504 of FIG. 5, the server 102 may provide to the generative AI models 612, 614 respective initialization information. For example, the server 102 may provide to the first generative AI model 612 an indication of the target language of the user and further information about the user (e.g., age, gender, name, location, mastery level of the target language, etc.). Additionally, the server 102 may provide to the second generative AI model 614 an indication of the natural language of the user and further information about the user (e.g., age, gender, name, location). In some examples, the first and/or second generative AI models 612, 614 may obtain this initialization information, or a portion thereof, in real time at the time of the conversation beginning with the user. In other examples, the first and/or second generative AI models 612, 614 may obtain this initialization information, or a portion thereof, in advance of the conversation in a setup stage or from a prior conversation (e.g., from a data store 110, system memory 218, or another memory).

Returning to FIG. 5, in some examples, in block 504, the server 102 can select the first avatar 602 and the second avatar 604 from a plurality of available avatars for the target language and the natural language, respectively. In some examples, each avatar can correspond to one of the available generative artificial intelligence models. The selection by the server 102 may be based on the particular language to be employed and on the initialization information.

At block 506, the server 102 generates a first interaction for the first avatar using the target language. In some examples, the first interaction can include a spoken interaction, which includes one or more spoken sentences, one or more spoken words, one or more written sentences, or one or more written words. In further examples, the server 102 generates the first interaction using the first avatar on the graphical user interface. Referring again to FIG. 6A, when the first interaction is provided to the user from the first avatar 602, the first avatar 602 can be displayed at a larger scale than the second avatar 604 on the graphical user interface. By displaying the first avatar 602 at a larger scale than the second avatar 604, the system can indicate to the user that the first avatar 602 is currently active in a conversation between the first avatar 602 and the user (e.g., speaking or listening to the user's interaction).

In some examples, the server 102 causes the lip and facial muscle of the first avatar 602 to move on a display of the client device 106, while generating corresponding audio (e.g., via a speaker on the client device 106), to speak the first interaction (e.g., a spoken interaction). In other interaction, the server 102 can provide the first interaction (e.g., a written interaction) on the graphical user interface of the client device 106. In some examples, the first avatar 602 can be associated with the first generative artificial intelligence model 612. In some examples, the server 102 can control the first avatar 602 to produce the first interaction using the first generative artificial intelligence model 612. For example, the server 102 may provide a conversation prompt (e.g., as text-based information) to the first generative artificial intelligence model 612, receive a response, and control the first avatar 602 to output the response as a spoken and/or written interaction. The first generative AI model 612 may generate the response using the conversation prompt and/or initialization information as inputs. For example, the conversation prompt and initialization information (or a portion thereof) may be provided as inputs to the first generative AI model 612, and the first generative AI model 612 may produce the response to the inputs. For example, the server 102 can control the first avatar 602 to have a conversation (e.g., interactions) about a certain topic (e.g., family, camping, travelling, etc.) with the user using the first generative artificial intelligence model 612. In some examples, the user can define the topic during the conversation or by providing user input (e.g., as part of block 502 using a keyboard, microphone, touch screen, etc. of the client device 106) that is transmitted to and received by the server 102 via network 120. The server 102 may provide the topic or user input to the first generative artificial intelligence model 612 to initiate the conversation on the topic (e.g., as a conversation prompt). In other examples, the first avatar 602 can determine or suggest the topic during the conversation (e.g., based on a generic conversation prompt to the first generative AI model 612 that does not specify a topic).

In some examples, in block 506, the first avatar 602 further receives a response from the user (e.g., in the target language). For example, the client 106 may receive user input (e.g., spoken input via a microphone or typed input via a keyboard or other human interface device) and transmit the user input to the server 102 via network 120. The server 102 may then provide the user input to the first generative AI model 612. The user input may be in the form of an audio data (e.g., as captured by the microphone) or text data (e.g., as typed or converted from audio captured by the microphone). The first avatar 602 implemented with the first generative AI model 612 can generate a follow-up question or interaction (spoken and/or written) in response to the user's response. For example, the server 102 may receive the follow-up question or interaction output by the first generative AI model 612 and control the first avatar 602 to output the follow-up question or interaction, as a spoken and/or written interaction. For example, the first avatar 602, using the first generative AI model 612, may ask about a learner's family member in the target language (e.g., English). Accordingly, in block 506, in some examples, the first avatar 602, via the server 102 and the first generative AI model 612, may have a conversation with the user, via the client device 106.

Referring again to FIG. 5, at block 508, the server 102 receives a user input (e.g., from the client device 106 of the user) to select the second avatar. For example, a graphical user interface screen 600A of FIG. 6A can include a second avatar 604 and/or an indication (e.g., “ask tutor”) of the second avatar 604. For example, the generated first interaction (e.g., the first sentence) from the first avatar 602 (e.g., in block 506) may include a question that asks about the user's niece and cousin in English. However, when the user does not know the vocabulary of niece and cousin in the target language spoken by the first avatar 602 (e.g., English), the server 102 can receive a user input to select the second avatar 604. The selection of the second avatar 604 may represent a request for assistance from the second avatar 604 with understanding and/or responding to the first sentence from the first avatar 602. The user input can include a mouse click of the second avatar 604 (see, e.g., user input 616), a voice command to select the second avatar 604, a keyboard input, or any other suitable input. The user input can indicate a request to translate the first interaction of the first avatar 602 to the natural language, a request to translate a specific word of the first interaction to the natural language, a request to provide one or more possible answers to respond to the first interaction in the target language and/or the natural language, or any other suitable input. Referring again to FIGS. 6A and 6B, when the user selects, via the user input 616, the second avatar 604 in FIG. 6A, the server 102 can enlarge and activate the second avatar 604 in the graphical user interface screen 600B as shown in FIG. 6B.

Referring again to FIG. 5, at block 510, the server 102 generates a second interaction for the second avatar using the natural language in response to the user input, where the second interaction corresponds to the first interaction. In some examples, the second interaction may be associated with the first interaction and may include one or more spoken sentences, one or more spoken words, one or more written sentences, or one or more written words. As noted above, the second avatar 604 can be associated with the second generative artificial intelligence (AI) model 614. In some examples, the second generative AI model 614 can communicate with the first generative AI model 612 to produce the second interaction. In some examples, the communicating of the second generative AI model 614 with the first generative AI model 612 includes transmitting the first interaction from the first generative AI model 612 to the second generative AI model 614. In some examples, the generating of the second interaction includes: receiving the second interaction from the second generative artificial intelligence model 614, which generates the second interaction based on the first interaction from the first avatar. Thus, the second generative artificial intelligence model 614 is aware of the interaction(s) between the first avatar 602 associated with the first generative AI model 612 and the user and can provide language assistance when the server 102 receives the user input to select the second avatar.

The second interaction generated by the second avatar 604 via the second generative AI model 614 may include one or more assistance interactions of various types. The assistance interactions may be in the natural language, the target language, or both the natural language and the target language. For example, the second interaction may include an assistance interaction that includes a translation of the first interaction (or portion thereof) of the first avatar 602 to the natural language. Additionally, or alternatively, the second interaction may include an assistance interaction in the target language. The assistance interaction can include one or more possible answers for the user to use to respond to the first interaction in the target language. Additionally, or alternatively, the second interaction may include an assistance interaction with one or more possible answers for the user to use to respond to the first interaction in the natural language. In some examples, the second interaction may include a first assistance interaction with one or more possible answers in the target language and a second assistance interaction corresponding to the first assistance interaction. Thus, the second assistance interaction can be a translation of the first assistance interaction to the natural language. In further examples, the generating of the second interaction may include: receiving the assistance interaction from the second generative artificial intelligence model 614, which generates the assistance interaction based on the first interaction from the first avatar 602. For example, when the first avatar 602 asks the user how many family members the user has (in the target language), and the user selects the second avatar 604, the second avatar 604 can provide, as a second interaction, one or more of the following assistance interactions: (1) a translation of the question “how many family members do you have” in the natural language, (2) one or more possible answers (e.g., “I have four family members,” “There are five peoples in my family,” etc.) in the target language, and/or (2) one or more possible answers (e.g., “I have four family members,” “There are five peoples in my family,” etc.) in the natural language. Each of the assistance interactions may be displayed as written text (on a display of the client device 106), spoken (via a speaker of the client device 106), or both. Thus, the user can understand the possible answers in the natural language as well.

Accordingly, with the process 500, when the user need assistance during the conversation in the target language with the first avatar 602, the user can select the second avatar 604, which can provide assistance to the user based on the context of the conversation between the user and the first avatar 602.

In some examples, after providing the second interaction (including the one or more assistance interactions) from the second (tutor) avatar 604, the server 102 can receive a user response from the user to the first interaction of the first avatar 602. The user response from the user may be received by the server 102 from the client device 106 via the network 120. This user response from the user may be an interaction (e.g., one or more spoken sentences, one or more spoken words, one or more written sentences, or one or more written words), which is similar to the first or second interaction. In some examples, the user response can be one of the possible answers provided by the second avatar 604 or a response originating from the user.

In further examples, the user response can be provided to the first avatar 602 (e.g., by the server 102) to continue the conversation between the user and the first avatar 602. In some such examples, the server 102 may loop back to block 506 to generate an avatar response (serving as a new “first sentence” or the first interaction) using the first generative AI model 612, and then proceed through blocks 508 and 510. This process may continue, thus enabling a user to carry on a conversation with the first avatar 602 in the target language and to seek and receive assistance from the second (tutor) avatar 604 in the natural language and/or the target language on demand. In some examples, during the conversation between the user and the first avatar 602 using the first generative AI model 612, the second AI model 614 may receive the conversation (e.g., the first interaction, the second interaction, the user response and the avatar response) and consider the prior conversion and/or the prior interaction(s) generated by the first AI model 612 to provide a proper assistance interaction (e.g., a translation of the conversation, one or more possible answers in the target and/or natural language) to the user.

In some examples, the server 102 can assess the user response for relevance and generate an avatar response accordingly. For example, when the first avatar 602 asks about the number of family members of the user (first interaction), and the user response is “I have twelve people in my class,” the server 102 determines that the response is irrelevant to the first interaction using the first generative AI model 612 or any other artificial intelligence model that may assess relevance. Then, the first avatar 602 can repeat the question or indicate the irrelevance of the response to the user. On the other hand, when the user's response indicates the size of the user's family and is, therefore, relevant, the first generative AI model 612 via the first avatar 602 can provide another question or statement associated with the user's response. As a more particular example, the server 102 can determine whether a relevance score of the user response is higher than a predetermined threshold. In some examples, in response to determining the relevance score is higher than the predetermined threshold, the server 102 can generate an avatar response from the first avatar 602. The avatar response can be responsive to the user response. In some examples, the avatar response can be an interaction (e.g., one or more spoken sentences, one or more spoken words, one or more written sentences, or one or more written words), which is similar to the first or second interaction. In this case, the avatar response may further the conversation and may include no direct reference to the relevance of the user response (e.g., because the user's response was indeed irrelevant). In some examples, in response to determining the relevance score is equal or lower than the predetermined threshold, the server 102 can provide an avatar response that indicates that the user response was irrelevant to the first interaction by the first avatar 602. As part of the avatar response indicating irrelevance, the first avatar 602 can also repeat the question (e.g., the first interaction).

Generally, the server 102 can receive user responses as text data (e.g., typed by keyboard at the client device 106) or audio data (e.g., captured by microphone at the client device 106). The server 102 can provide the user responses (e.g., as text data or audio data) to the first generative AI model 612. In some examples, the server 102 can convert the audio data to text data and provide the converted text data to the first generative AI model 612 for an avatar response in the target language. The audio data from the user may also be referred to as a spoken interaction. The text data input to the first generative AI model 612 may also be referred to as a written interaction provided to the first generative AI model 612. The first generative AI model 612 may generate, in response, an avatar response or a response interaction in the target language. The server 102 may then receive the avatar response or response interaction from the first generative AI model 612, and provide the response interaction by the first avatar 602 to the user via the client device 106. The server 102 may repeat the process (e.g., by receiving a user response from the user and providing an avatar response in response to the user response).

In some examples, the avatars may have various characteristics, such as, for example, an accent, a voice tone, an age, a speaking style, a job, an education level based on a job, or any other suitable characteristic of a person. In some examples, a first characteristic of the first avatar 602 associated with the first generative artificial intelligence model 612 is different from a second characteristic of the second avatar associated with the second generative artificial intelligence model 614. In some examples, the server 102 can assign the first characteristic to the first generative artificial intelligence model 612 being associated with the first avatar 602 and assign the second characteristics to the second generative artificial intelligence model 614 being associated with the second avatar 604. In some examples, the characteristic (i.e., the first characteristic or the second characteristic) can include an accent, a voice tone, an age, a speaking style, a job, an education level based on a job, or any other suitable characteristic of a person. As an example, when the server 102 assigns a college student with an English major as a characteristic to the first avatar 602, the first generative artificial intelligence model 612 can generate interactions based on the college student with an English major.

In some examples, when the first interaction is provided from the first avatar 602, the server 102 can generate the first avatar 602 as larger than the second avatar 604 on the graphical user interface.

Referring to FIG. 6C, the server 102 can provides a graphical user interface screen 600C including the second avatar 604 to communicate with the user in the natural language. The second avatar 604 is connected to the second generative artificial intelligence model 614 and produce interaction(s) in response to the user's interaction using the second generative artificial intelligence model 614. Referring to FIGS. 6A-6C, in some examples, the first avatar 602 with the first generative intelligence model 612 and/or the second avatar 604 with the second generative intelligence model 614 can assess the user response in real time and provide feedback to the user in real time.

Referring to FIG. 6D, the server 102 can provide a graphical user interface screen 600D including the second avatar 604 to provide feedback or an assessment result about a user response to an interaction (e.g., a question, a suggestion, etc.) of the first avatar 602. For example, after the user responds to a question from the first avatar 602, the user can select the second avatar 604 as shown in FIG. 6B. Then, as shown in FIG. 6D, the server 102 can display the first avatar 602 as a background image by blurring the first avatar 602 and display the second avatar 604 over the image of the first avatar 602 along with the assessment result 618. In some examples, the server 102 can provide the assessment result 618 as a summary of the assessment of the response from the user (e.g., as part of or following block 510 in FIG. 5). For example, the assessment result 618 can summarize how many errors the response includes, how many words (e.g., key words, suggested words, etc.) the response includes or should include, how many phrases (e.g., key phrases, suggested phrases, etc.) the response includes or should include, or any other suitable assessment. In such examples, when the user selects (e.g., clicks) an item in the assessment result 618, the server 102 can provide detail information about the assessment result 618. For example, when the user selects a summary indication 620 showing how many errors the response includes, the server 102 can display the response the user provided and a corrected response. In further examples, the server 102 can display a corrected response and any other suggested alternative response. Also, when the user selects a summary indication 620 showing how many words or phrases the response includes, the server 102 can display a list of key vocabularies or phrases in response to the interaction of the first avatar 602. Additionally or alternatively, the server 102 can include which vocabulary or phrase the response used in the list of key vocabularies or phrases. In other example, the server 102 can provide the assessment result 618 in detail without the summary assessment result when the user clicks the second avatar 604. Thus, the server 102 can provide an assessment result of each response of the user to an interaction from the first avatar 602 in real-time or near real-time.

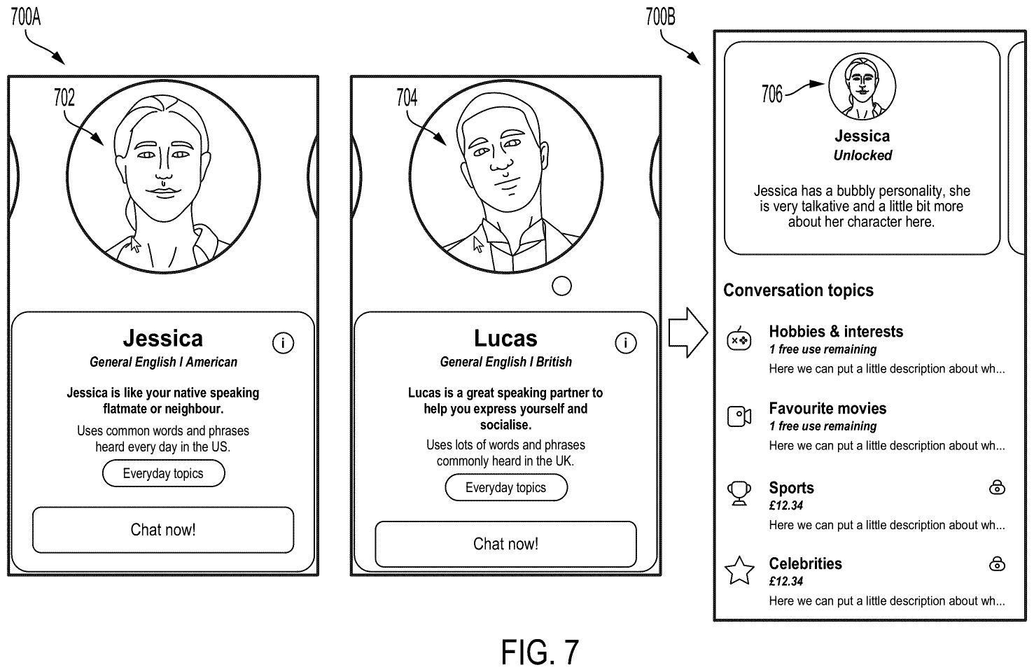

FIGS. 7-10 illustrate various graphical user interface screens that may be implemented or used as part of one or more examples of the process 500 of FIG. 5, or independent of the process 500.

Referring to FIG. 7, the server 102 can provide a graphical user interface screen 700A to show different avatars 702, 704 to select to serve as the first avatar 602. For example, the server 102 can provide a graphical user interface screen 700A to include multiple avatars 702, 704 (e.g., as part of block 504 of FIG. 5). Multiple avatars can have different characteristics (e.g., characters, accents, education levels, accent, ages, speaking styles, jobs, interests, and/or any other suitable characteristics) and speak based on the characteristics. For example, an avatar 702 uses the American English accent and likes to talk about everyday life with the user. Thus, when the user selects the avatar 702, the server 102 can limit the topics to everyday life topics (e.g., hobby, sports, etc.). On the other hand, another avatar 704 uses the British accent and phrases and helps the user express oneself and socialize. Thus, when the user selects the avatar 704, the server 102 can limit the topics in a social event. Additionally or alternatively, the server 102 can provide an additional graphical user interface screen 700B for an avatar to provide further information about the avatar or modify the character of the avatar. For example, an avatar 706, selectable by the user, can discuss hobbies, interests, and favorite movies. When the user adds a description about a sport (e.g., baseball), the server 102 prepares the avatar 706 to be ready to discuss the sport that the user added. In some examples, although the server 102 can limit the topics for the user to converse with the avatar 706, the user can broaden the topics such that the server 102 trains the avatar 706 to learn from the user's added description. In other examples, the server can lift restrictions about the topics that the user can discuss with the avatar 706 based on the user's added description. In response to a user selection of the avatar 702, 704, or 706 (the selected avatar), which is received by the server 102, the server 102 may set the first avatar 602 in FIG. 6A-6D to be the selected avatar. In some examples, the server 102 may provide the characteristics of the selected avatar to the first generative AI model 612 to assist in defining the first avatar 602 (e.g., as initialization information in block 504 of FIG. 5), which the first generative AI model 612 may use to generate output language for conveying to a user via the first avatar 602.

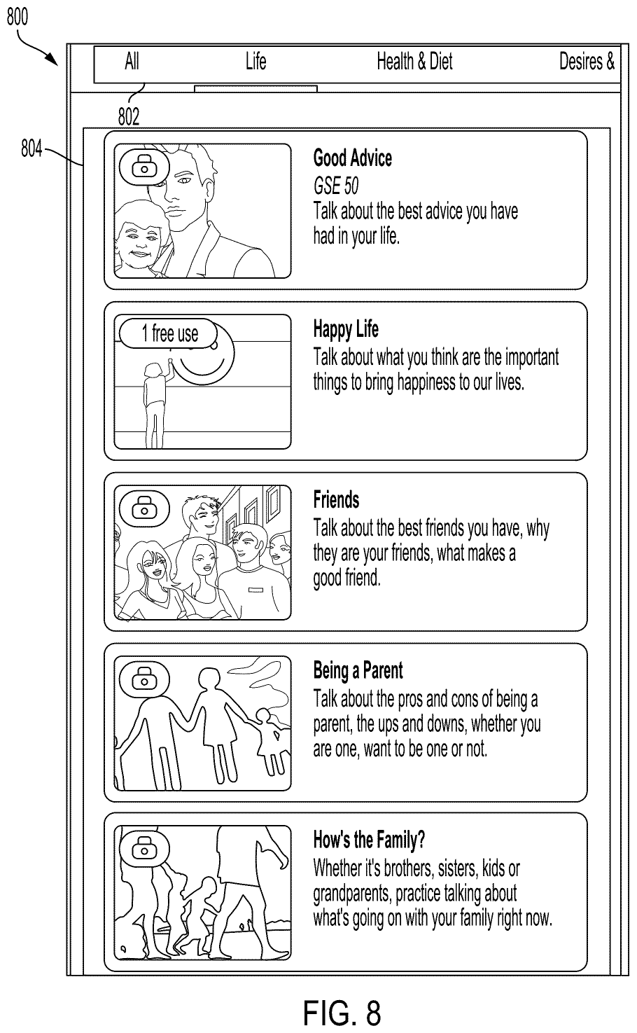

Referring to FIG. 8, the server 102 can provide a list of topics for the user to speak with an avatar on a graphical user interface screen 800. For example, the server 102 can provide general topics 802 and specific topics 804 based on a general topic on the screen 800 (e.g., as part of block 504 of FIG. 5). In response to receiving, via the screen 800, a user selection of one of the topics displayed, the server 102 may provide the topic to the AI model 612 and/or the AI model 614 as initialization information (e.g., in block 504 of FIG. 5). Thus, the user can focus on a topic to speak with the avatar and learn language about the topic.

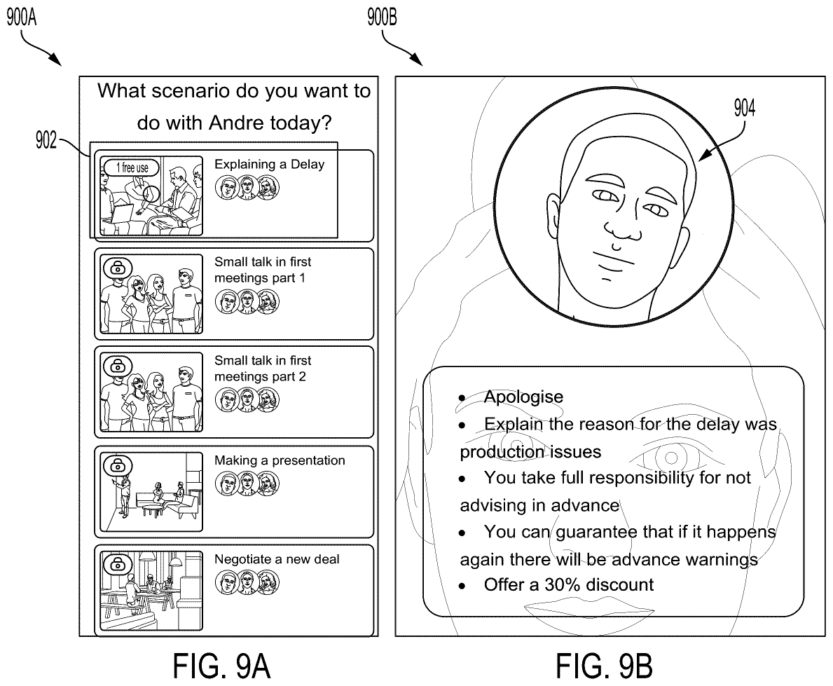

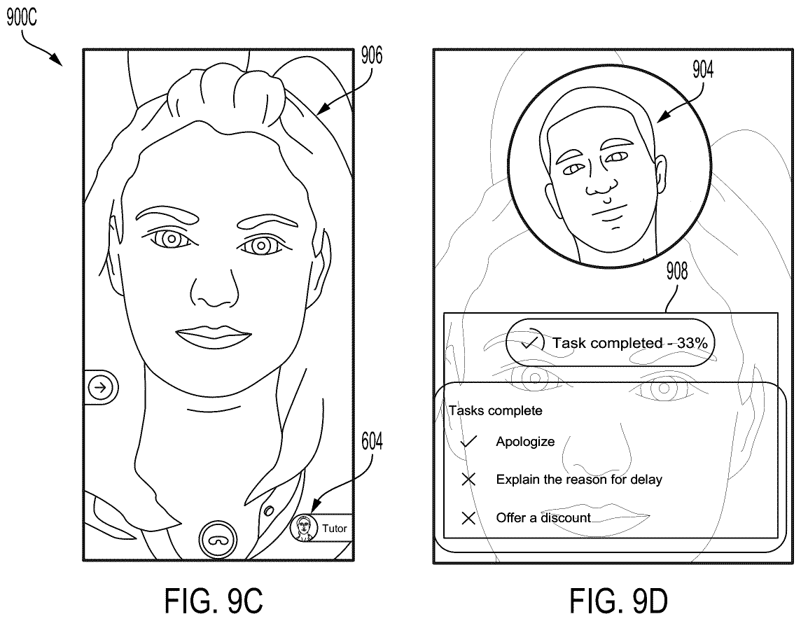

Referring to FIGS. 9A-9D, the server 102 can provide an environment to perform a role play for a specific topic or scenario between the user and an avatar. For example, the server 102 can provide a list of scenarios for the user to select on a graphical user interface screen 900A as shown in FIG. 9A. The scenario can be any suitable scenario. For example, the scenario, can be a particular business scenario (e.g., explaining a delay, presenting a product, negotiating a new deal, etc.), a social event scenario (e.g., introducing myself in a social event, etc.), an everyday life scenario (e.g., introducing a favorite movie, explaining a hobby, calling a repair to a plumber, etc.) or any suitable scenario. In response to receiving, via the screen 900A, a user selection of one of the scenarios displayed, the server 102 may provide the scenario to the AI model 612 and/or the AI model 614 as initialization information (e.g., in block 504 of FIG. 5). In some examples, the user can select a scenario explaining a delay 902. Then, the server 102 can provide tasks or instructions to accomplish as shown in a screen 900B of FIG. 9B. As an example, an avatar 904 can explain tasks that the user should complete when the user converses with another avatar. In the examples of the scenario explaining a delay 902, the server 102 can provide tasks (e.g., apologize, explain the reason for the delay, offer a 30% discount, etc.) via the avatar 904. Referring to FIG. 9C, the server 102 can provide an example screen 900C of a GUI for another avatar 906 for the role play based on the tasks given to the user. In some examples, the avatar 906 can be the first avatar 602 in FIG. 6A-6D (e.g., speaking in the target language to be learned by the user), and the user can use the second avatar 604 (e.g., speaking in the user's native language) to facilitate or assess the conversation with the avatar 906. In such examples, the avatar 906 explains a situation and/or asks a question associated with the tasks given to the user (e.g., as part of block 506 of FIG. 5). In response to the interaction from the avatar 906, the user can provide a response to the server 102 (e.g., as part of block 508 of FIG. 5). Referring to FIG. 9D, the server 102 can provide an example screen 900D of a GUI for an assessment result 908 for the role play. The avatar 904 who provided tasks to the user in FIG. 9B can provide an assessment result to the user (e.g., as part of or following block 510 in FIG. 5). For example, the server 102 can provide a summary of accomplished tasks (e.g., task completed-33%) and detail results (e.g., the apologizing task is completed while tasks about explaining the reason and offering a discount are not completed). Additionally, the server 102 can provide a suggestion to complete the uncompleted tasks.

In some examples, the system and methods provided herein can be described as having three “layers” that can deliver realistic speaking practice and personalized tutoring support. For example, layer 1 can indicate custom user interface/front end with two highly realistic digital human avatars. The server 102 can generate a custom user interface with two highly realistic digital human avatars that are rendered live and that demonstrate high degrees of empathy and contextual understanding by demonstrating emotions, gaze, and with realistic facial expressions and lip-sync. The custom interface seamlessly switches between the tutor avatar and the conversation avatar, allowing learner to role-play scenarios with a first avatar 602 (e.g., a conversation partner) while receiving feedback from a second avatar 604 (e.g., a tutor). While the first avatar 602 appears in full-screen mode, the second avatar 604 is available in the upper lower corner for on-demand support. When clicked on, the second avatar 604 provides translation of what the first avatar 602 has just said and offers recommended ways to respond back to the first avatar 602. Layer 2 can indicate conversational ability to listen to and to speak to the learner: In the layer 2, both digital human avatars are connected to speech to text and text to speech capabilities that allow both digital human avatars to “hear” users and to “speak back” to users. These services are connected to the layer three for natural language understanding and natural language generation. Layer 3 can indicate a generative artificial intelligence model with custom prompts. In layer 3, both digital human avatars 602, 604 are connected to corresponding generative artificial intelligence models for natural language processing, understanding and generation. Each digital human is programmed via prompt engineering to have semi-structured conversations with the learner. The first avatar 602 is instructed to have role-plays around life scenarios (e.g., talking about family) while the second avatar 604 is instructed to provide translation from the target language to the learner's native language with recommendations on how to respond to the first avatar 602 and/or an assessment result of the response of the user. Both the first avatar 602 and the second avatar 604 can respond to users' answers and questions.

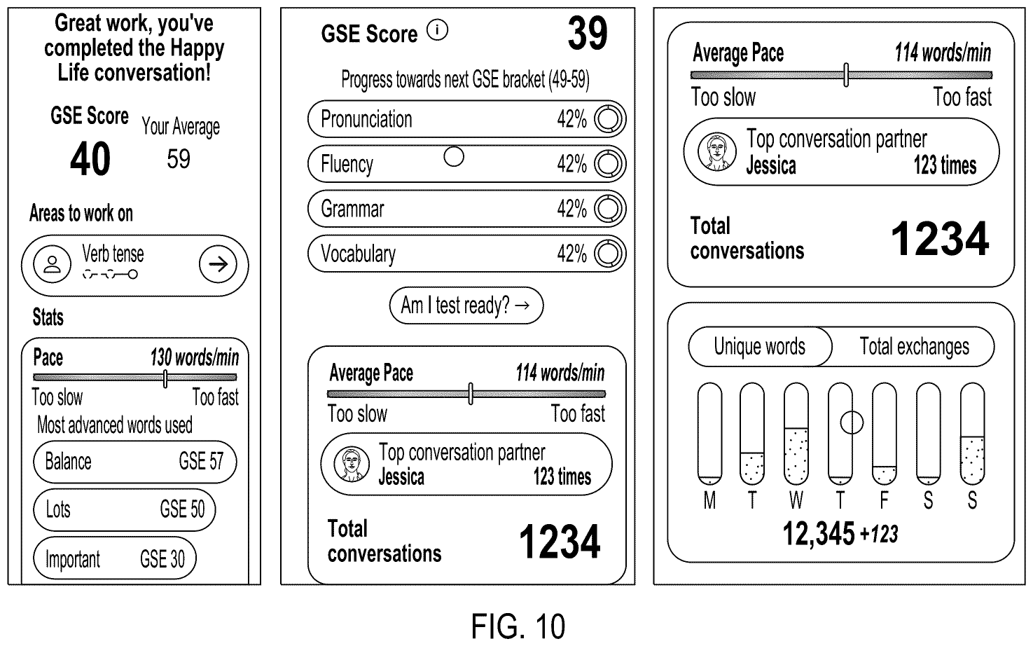

Referring to FIG. 10, example screens of GUIs for assessment results are shown. For example, the server 102 can provide an assessment result for each topic, conversation, or sentence. The assessment result can include a quantified score of the user's responses, a level of the topic, a speed of speaking, vocabulary statistics that the user used, and any other suitable assessment result. Additionally or alternatively, the server 102 can provide an assessment result for user's entire performance. For example, the server 102 can quantify levels of pronunciation, fluency, grammar, and/or vocabulary based on the user's prior responses to avatars. The assessment result can be any other suitable result or statistics. In some examples, the server 102 may provide the assessment via one or more of the screens of FIG. 10 as part of or following block 510 of FIG. 5.

The aforementioned systems and methods can be used in various scenarios. For example, the systems and methods can provide conversational practice with a personal tutor for general language learning. In another example, the system and methods can be integrated into an existing language learning application (e.g., a mobile “app” on a mobile phone). For example, after completing short lessons on the existing language learning application, learners will be able to launch conversations with the conversation partner/tutor to practice applying what they've learned in real life-like conversations. In other examples, the systems and methods can provide personal digital wizard tutor. For example, digital human tutors can allow to create personal AI digital human tutors that follow a methodology (e.g., the Wizard methodology) and that will provide a more personalized and more affordable language learning experience to learners who currently receive limited 1:1 time with human teachers, due to large class sizes. In further examples, the systems and methods can provide personalized business English coach. For example, the systems and methods can provide a personalized business language (Business English) offerings to help individuals develop language skills for work and to help organizations upskill their employees language and communication skills with an affordable & scalable solution.

In an example, the systems and methods described herein (e.g., the system 300, the process 500, etc.) may also enable an efficient technique for improving communication skills in a target language such that the system provides one or more human-like avatars to communicate with a user in real time using one or more generative artificial intelligence models. Such interaction of a learner with avatar(s) in real-time improves learner's learning ability due to spontaneous feedback and spontaneous interactions and communication with human-like avatar(s).

Other examples and uses of the disclosed technology will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its embodiments.

What is claimed:

1. A method for artificial intelligence-based language skill assessment and development using avatars, comprising:
determining, by an electronic processor, a target language and a natural language of a user;
generating, by the electronic processor, a first avatar corresponding to the target language and a second avatar corresponding to the natural language on a graphical user interface;
generating, by the electronic processor, a first interaction for the first avatar using the target language, the first avatar being associated with a first generative artificial intelligence model;
receiving, by the electronic processor, a user input to select the second avatar; and
in response to the user input, generating, by the electronic processor, a second interaction for the second avatar using the natural language, the second interaction being associated with the first interaction, the second avatar being associated with a second generative artificial intelligence model, the second generative artificial intelligence model communicating with the first generative artificial intelligence model to produce the second interaction.

2. The method of claim 1, wherein the communicating of the second generative artificial intelligence model with the first generative artificial intelligence model comprises: transmitting the first interaction from the first generative artificial intelligence model to the second generative artificial intelligence model,
wherein the second interaction comprises one or more assistance interactions, and
wherein the generating of the second interaction comprising: receiving the one or more assistance interactions from the second generative artificial intelligence model, which generates the one or more assistance interactions based on the first interaction.

3. The method of claim 1, wherein a first characteristic of the first avatar being associated with the first generative artificial intelligence model is different from a second characteristic of the second avatar being associated with the second generative artificial intelligence model.

4. The method of claim 3, further comprising:
assigning, by the electronic processor, the first characteristic to the first generative artificial intelligence model being associated with the first avatar; and
assigning, by the electronic processor, the second characteristic to the second generative artificial intelligence model being associated with the second avatar.

5. The method of claim 1, wherein the determining of the target language and the natural language comprises: selecting, by the electronic processor, the first avatar and the second avatar from a plurality of available avatars for the target language and the natural language, respectively, each avatar of the plurality of available avatars corresponding to one of a plurality of available generative artificial intelligence models.

6. The method of claim 1, wherein the second interaction comprises a first assistance interaction in the target language, the first assistance interaction comprising one or more possible answers to respond to the first interaction.

7. The method of claim 6, wherein the second interaction further comprises a second assistance interaction in the natural language, the second assistance interaction corresponding to the first assistance interaction.

8. The method of claim 1, further comprising:
receiving, by the electronic processor, a user response from the user, the user response being responsive to the first interaction; and
determining, by the electronic processor, whether a relevance score of the user response is higher than a predetermined threshold.

9. The method of claim 8, further comprising:
in response to determining the relevance score is higher than the predetermined threshold, generating, by the electronic processor, an avatar response from the first avatar, the avatar response being responsive to the user response.

10. The method of claim 8, further comprising:
in response to determining the relevance score is equal or lower than the predetermined threshold, providing, by the electronic processor, an avatar response from the first avatar, the avatar response being indicative of irrelevance to the user response.

11. The method of claim 8, wherein the user response is a spoken interaction,
wherein the method further comprises:
converting, by the electronic processor, the spoken interaction to a written interaction;
inputting, by the electronic processor, the written interaction to the first generative artificial intelligence model for an avatar response in the target language;
receiving, by the electronic processor, the avatar response from the first generative artificial intelligence model; and
providing, by the electronic processor, the avatar response by the first avatar to the user.

12. The method of claim 1, wherein each of the first interaction and a second interaction are a spoken interaction.

13. The method of claim 1, further comprising: when the first interaction is provided from the first avatar, displaying, by the electronic processor, the first avatar at a larger scale than the second avatar on the graphical user interface.

14. A system for artificial intelligence-based language skill assessment and development using avatars, comprising:
a memory; and
an electronic processor coupled with the memory,
wherein the electronic processor is configured to:
determine a target language and a natural language of a user;
generate a first avatar corresponding to the target language and a second avatar corresponding to the natural language on a graphical user interface;
generate a first interaction for the first avatar using the target language, the first avatar being associated with a first generative artificial intelligence model;
receive a user input to select the second avatar; and
in response to the user input, generate a second interaction for the second avatar using the natural language, the second interaction corresponding to the first interaction, the second avatar being associated with a second generative artificial intelligence model, the second generative artificial intelligence model communicating with the first generative artificial intelligence model to produce the second interaction.

15. The system of claim 14, wherein to communicate the second generative artificial intelligence model with the first generative artificial intelligence model, the electronic processor is configured to: transmit the first interaction from the first generative artificial intelligence model to the second generative artificial intelligence model,
wherein the second interaction comprises one or more assistance interactions, and
wherein to generate the second interaction, the electronic processor is configured to receive the one or more assistance interactions from the second generative artificial intelligence model, which generates the one or more assistance interactions based on the first interaction.

16. The system of claim 14, wherein a first characteristic of the first avatar being associated with the first generative artificial intelligence model is different from a second characteristic of the second avatar being associated with the second generative artificial intelligence model.

17. The system of claim 16, wherein the electronic processor is further configured to:
assign the first characteristic to the first generative artificial intelligence model being associated with the first avatar; and
assign the second characteristic to the second generative artificial intelligence model being associated with the second avatar.

18. The system of claim 14, wherein to determine the target language and the natural language, the electronic processor is configured to: select the first avatar and the second avatar from a plurality of available avatars for the target language and the natural language, respectively, each avatar of the plurality of available avatars corresponding to one of a plurality of available generative artificial intelligence models.

19. The system of claim 14, wherein the second interaction comprises a first assistance interaction in the target language, the first assistance interaction comprising one or more possible answers to respond to the first interaction.

20. The system of claim 19, wherein the second interaction further comprises a second assistance interaction in the natural language, the second assistance interaction corresponding to the first assistance interaction.

21. The system of claim 14, wherein the electronic processor is further configured to:
receive a user response from the user, the user response being responsive to the first interaction; and
determine whether a relevance score of the user response is higher than a predetermined threshold.

22. The system of claim 21, wherein the electronic processor is further configured to:
in response to determining the relevance score is higher than the predetermined threshold, generate an avatar response from the first avatar, the avatar response being responsive to the user response.

23. The system of claim 21, wherein the electronic processor is further configured to:
in response to determining the relevance score is equal or lower than the predetermined threshold, provide an avatar response from the first avatar, the avatar response being indicative of irrelevance to the user response.

24. The system of claim 21, wherein the user response is a spoken interaction,
wherein the electronic processor is further configured to:
convert the spoken interaction to a written interaction;
input the written interaction to the first generative artificial intelligence model for an avatar response in the target language;
receive the avatar response from the first generative artificial intelligence model; and
provide the avatar response by the first avatar to the user.

25. The system of claim 14, wherein each of the first interaction and a second interaction are a spoken interaction.

26. The system of claim 14, wherein the electronic processor is further configured to: when the first interaction is provided from the first avatar, display the first avatar at a larger scale than the second avatar on the graphical user interface.
